(19) United States
(12) Patent Application Publication
(10) Pub. No.: US 2022/0125069 A1
(43) Pub. Date: Apr. 28, 2022

(54) Nut Butter Composition

(71) Applicant: General Mills, Inc., Minneapolis, MN (US)

(72) Inventor: Kevin Bock, Minneapolis, MN (US)

(73) Assignee: General Mills, Inc., Minneapolis, MN (US)

(21) Appl. No.: 17/435,538

(22) PCT Filed: Mar. 14, 2019
(86) PCT No.: PCT/US2019/022180

§ 371 Date: Sep. 1, 2021

(51) Int. Cl. A23G 1/54; A23G 3/54; A21D 13/38; A21D 13/28; A21D 13/24; A23P 20/10; A23P 30/20; A23L 25/10

(52) U.S. Cl. CPC A23G 1/54; A23G 3/54; A21D 13/38; A23L 25/10; A21D 13/24; A23P 20/10; A23P 30/20; A21D 13/28

(57) ABSTRACT

A nut butter composition is disclosed that includes a nut butter, a palm oil stearin fraction, and a powdered food ingredient, and methods of making same. Food products including a nut butter compositions and methods of making are also disclosed.

### BACKGROUND

Nut butters, such as peanut butter and almond butter, are particularly enjoyed by consumers for their pleasant flavor, aroma, and texture. However, nut butters included in convenience foods, such as shelf-stable snacks, are often modified to improve shelf stability and handling during manufacturing, which frequently sacrifices some of the desired eating qualities of the nut butters. Thus, a new challenge has been to produce foods that fulfill the need for enjoyable, shelf stable foods containing nut butters, while retaining the pleasant eating experience of the nut butters alone.

### SUMMARY

The present disclosure relates to a food composition containing a nut butter.

A food composition is disclosed herein. In some embodiments, a food composition can include a nut butter in an amount of from about 50% to about 78% by weight of the food composition, the nut butter having a grind of at least 4 mils as measured using a Hegman gauge, a palm oil stearin fraction in an amount of about 1.5% to about 7% of the food composition, and a powdered food ingredient in an amount of about 20% to about 45% of the food composition, the powdered food ingredient having a median particle size less than 100 μm. In some embodiments, a food composition can include a nut butter in an amount of from about 50% to about 83% by weight of the food composition, the nut butter having a grind of at least 4 mils as measured using a Hegman gauge, a palm oil stearin fraction in an amount of about 1.5% to about 7% of the food composition, and a powdered food ingredient in an amount of about 15% to about 45% of the food composition, the powdered food ingredient having a median particle size less than 100 μm, and including a sugar or sugar alcohol in an amount of at least 15% by weight of the food composition.

In some embodiments, a food composition provided herein can include a nut base in an amount of from about 55% to about 85% of the food composition, the nut base including the nut butter in an amount of from about 90% to about 97% by weight of the nut base, and the palm oil stearin fraction in an amount of from about 3% to about 8% of the nut base, the palm oil stearin fraction having a melt point of at least 130° F.

In some embodiments, a powdered food ingredient can be included in the food composition in an amount of from about 25% to about 45%. In some embodiments, a powdered food ingredient can be included in the food composition in an amount of from about 20% to about 35%. In some embodiments, a powdered food ingredient in a food composition provided herein can include a starch or a flour.

In some embodiments, a food composition provided herein can include salt in an amount of about 0.5% to about 2.5% by weight of the composition.

In some embodiments, a nut butter in a food composition provided herein can include peanut butter and the palm stearin fraction can be included in an amount of from about 1.5% to about 5% of the composition.

In some embodiments, a nut butter in a food composition provided herein can include almond butter and the palm stearin fraction can be included in an amount of from about 2% to about 7% of the composition.

Also provided is a method of making a food product, the method including combining food ingredients to make a food composition, the food composition including a nut butter in an amount of from about 50% to about 78% by weight of the food composition, a palm oil stearin fraction in an amount of from about 1.5% to about 7% by weight of the food composition, the palm oil stearin fraction having a melt point of at least 130° F., and a powdered food ingredient in an amount of about 20% to about 45% by weight of the food composition, the powdered food ingredient having a median particle size of less than 100 μm, extruding the food composition to make an extruded food composition, and portioning the extruded food composition into pieces to make the food product.

In some embodiments of a method provided herein, a powdered food ingredient can include a sugar, a starch, or a flour.

In some embodiments, a method can further include a step of applying a coating to at least a portion of a surface of the pieces.

In some embodiments, the coating can include chocolate or a compound coating.

In some embodiments, a method can further include a step of applying a particulate to the coating.

In some embodiments, an extruded food composition can be extruded at a temperature of about 60° F. to about 90° F.

Another method of making a food product is provided herein. The method includes providing a heated food composition at a temperature of from about 120° F. to about 140 ° F., the food composition being a pumpable liquid or semi-liquid and including a nut butter in an amount of from about 63% to about 83% by weight of the food composition, a palm oil stearin fraction in an amount of from about 1.5% to about 7% by weight of the food composition, the palm oil stearin fraction having a melt point of at least 130° F., and a powdered food ingredient in an amount of about 15% to about 30% by weight of the food composition, the powdered food ingredient having a median particle size of less than 100 μm, and including a sugar or sugar alcohol in an amount of at least 15% by weight of the food composition, applying the heated food composition to a surface of a solid food article, and cooling the heated food composition on the surface of the solid food article to a temperature below 90° F. to make the food product.

In some embodiments, a solid food article can comprise a grain-based article. In some embodiments, a solid food article can comprise a cooked dough-based article.

In some embodiments, a method can further include applying a food ingredient to the food composition before cooling the food composition. In some embodiments, a food ingredient can include confectionary pieces, nuts or nut pieces, seeds, or a second solid food article.

Another method of making a food product is provided herein. The method includes providing a first food composition at a temperature of from about 120° F. to about 140° F., the first food composition being a pumpable liquid or semi-liquid and including a nut butter in an amount of from about 63% to about 83% by weight of the first food composition, a palm oil stearin fraction in an amount of from about 1.5% to about 7% by weight of the first food composition, the palm oil stearin fraction having a melt point of at least 130° F., and a powdered food ingredient in an amount of about 15% to about 30% by weight of the first food composition, the powdered food ingredient having a median particle size of less than 100 um, and including a sugar or sugar alcohol in an amount of at least 15% by weight of the food composition, extruding a second food composition, extruding or injecting the first food composition with the second food composition, and forming the first food composition and second food composition such that the second food composition substantially surrounds the first food composition to make the food product.

In some embodiments, a second food composition can be a dough.

In some embodiments, a method can further include a step of cooking the food product.

In some embodiments, a powdered food ingredient can include a sugar in an amount of at least 15% by weight of the food composition.

In some embodiments, any of the disclosed methods can further include packaging the food product.

These and various other features and advantages will be apparent from a reading of the following detailed description.

### DETAILED DESCRIPTION

The present disclosure relates to a food composition containing a nut butter, where the nut butter has benefits in shelf stability and manufacturability for use in a shelf-stable food, but also retains an eating experience that closely resembles a nut butter alone. As used herein, a nut butter refers to a semi-solid paste made from ground nuts (e.g., tree nuts, peanuts, and the like). A nut butter contains only ingredients made from ground nuts, and, optionally, salt. Any edible nut butter can be used in a food composition, including without limitation, peanut butter, cashew butter, hazelnut butter, almond butter, or the like, or combinations thereof.

It was discovered, and is disclosed herein, that a food composition containing a relatively high nut butter content can be combined with a palm oil stearin fraction and a powdered food ingredient to achieve a unique combination of shelf stability, temperature abuse stability, and manufacturing and handling benefits, while retaining eating characteristics that closely resemble the nut butter alone.

A food composition provided herein includes a nut butter (e.g., peanut butter, almond butter, cashew butter, hazelnut butter, or the like, or combinations thereof) in an amount of from about 50% to about 83% by weight of the food composition. A nut butter suitable for use in a composition provided herein has a grind of at least 4 mils (e.g., the largest particle size is at least 4 one-thousandths of an inch) as measured using a Hegman gauge.

A food composition provided herein includes a palm oil stearin fraction in an amount of from about 1.5% to about 7% (e.g., about 1.5% to about 5%, or about 2% to about 7%) by weight of the food composition. In some embodiments, the amount of a palm oil stearin fraction included in a food composition provided herein can be adjusted based on the nut butter type. For example, a food composition including almond butter can include from about 2% to about 7% palm oil stearin fraction to improve shelf stability of the highly unsaturated native oils in the almond butter. In another example, a food composition including peanut butter can include from about 1.5% to about 5% palm oil stearin fraction to improve shelf stability of the moderately saturated native oils in the peanut butter. It is to be understood that the palm oil stearin fraction can be adjusted based on additional types of nut butters, as well as blends of nut butters.

In some embodiments, the amount of a palm oil stearin fraction included in a food composition provided herein can be adjusted based on the grind of the nut butter. The grind of a nut butter can increase (for a finer grind) or decrease (for a coarser grind) the amount of free native oil in the nut butter. As such, the amount of palm oil stearin fraction included in a food composition that has a more finely ground nut butter can be higher, while the amount of palm oil stearin fraction included in a food composition that has a more coarsely ground nut butter can be lower.

A palm oil stearin fraction suitable for use in a food composition provided herein has a melt point as measured by Mettler Dropping Point of at least 130° F. (e.g., at least 135° F., or about 140° F.).

A food composition provided herein includes a powdered food ingredient having a median particle size of less than 100 μm (e.g., 50 μm or less). A powdered food ingredient can be any edible powder, such as a sugar, a starch, a flour, or the like, or any combination thereof.

In some embodiments, a powdered food ingredient can be included in an amount of about 15% to about 45% by weight of a food composition, where a sugar or sugar alcohol is included in an amount of at least 15% by weight of the food composition. In some embodiments, a powdered food ingredient can be included in a food composition in an amount of about 20% to about 45% (e.g., about 25% to about 45%) by weight of the food composition.

In some embodiments, a powdered food ingredient can be included in a food composition in an amount sufficient (e.g., from about 15% to about 45% by weight, from about 25% to about 45% by weight, or from about 30% to about 45% by weight) to achieve a structure that is a malleable solid at a temperature of about 50° F. to about 100° F. (e.g., from about 60° F. to about 90° F.). Such a composition can be formed using, e.g., an extruder fitted with a die and cutter, and retain its shape at a temperature of about 50° F. to about 100° F.

In some embodiments, a powdered food ingredient can be included in a food composition in an amount sufficient (e.g., from about 15% to about 45% by weight, from about 15% to about 30% by weight, or from about 20% to about 35% by weight) to achieve a structure that is pumpable (e.g., liquid or semi-liquid) at a temperature of above 120° F. (e.g., 120° F. to about 130° F.) once heated to melting at a temperature above 140° F. (e.g., above 145° F.), and solidifies at a temperature at or below 100° F. (e.g., 90° F.). In some embodiments, a composition can begin to solidify at a temperature of around 115°, and be solid at a temperature at or below 100° F. Such a composition can be applied as a filling (e.g., in a granola cup, or between two cookies), or as a topping, coating, or footing (e.g., on a cookie or granola bar) to produce a food product, and will retain its form throughout the shelf life of the food product.

In some embodiments, a food composition provided herein can include other ingredients. For example, a food composition can include salt in an amount of from about 0.5% to about 2.5% by weight of the food composition. In some embodiments, a food composition provided herein can include 5% or less (e.g., 2.5% or less) other ingredients. In some embodiments, a food composition provided herein can consist of a nut butter, a palm oil stearin fraction, a powdered food ingredient, and salt. In some embodiments, a food composition can consist of a nut butter, a palm oil stearin fraction, and a powdered food ingredient.

A food composition provided herein can be produced in any appropriate manner. For example, a nut base can be produced by combining a nut butter in an amount of from about 90% to about 97% of the nut base, with a palm oil stearin fraction in an amount of about 3% to about 8% of the nut base. In some embodiments, a nut base can include salt in an amount of about 1% to about 4% by weight of the nut base. A nut base in an amount of about 55% to about 85% by weight can be combined with a powdered food ingredient in an amount of about 15% to about 45% by weight to produce a food composition provided herein.

Any appropriate equipment can be used to produce a food composition provided herein, such as a mixer, or an extruder, or the like.

In some embodiments, food composition provided herein can be produced and stored and/or packaged alone. In some embodiments, a stored and/or packaged food composition can be later used to make a food product. For example, in some embodiments, a food composition provided herein can be used in a food product, such as a snack bar, a filled baked good, a coated nut butter bite, or a filled granola cup.

In some embodiments, a method of making a food product can include extruding a food composition provided herein and portioning the extruded food composition into pieces to make the food product. In some embodiments, an extruded food composition can include a powdered food ingredient in an amount of from about 20% to about 45% (e.g., from about 25% to about 45%) by weight of the food composition. A powdered food ingredient in an amount of from about 20% to about 45% by weight can contribute to a structure that is pliable near room temperature. In some embodiments, an extruded food composition can be extruded at a temperature of about 60° F. to about 90° F. (e.g., about 65° F. to about 85° F.).

In some embodiments, extruded food composition pieces can be at least partially coated. Suitable coatings include, for example, chocolate-based coatings and compound coatings. For example, extruded food composition pieces can be coated using a chocolate-based composition described in the co-pending patent application titled “Chocolate-based food composition” by Bock, filed Mar. 14, 2019. In some embodiments, a coating can comprise a particulate. Suitable particulates include, for example, nut pieces, granola, rolled oats, coconut, or powders (e.g., cocoa powder, coconut flour), and the like, or combinations thereof.

In some embodiments, a food composition provided herein can be applied to a surface of a solid food article (e.g., a grain-based article, a dough-based article, or the like) to produce a food product. For example, a food composition provided herein can be used to fill a granola cup, or as a layer between two cookies. In some embodiments, a food composition provided herein can be applied to a granola bar as a layer on top, on the bottom, or between the granola bar and another food ingredient (e.g., another bar, chocolate, nuts, or the like).

In some embodiments, a method of making a food product can include providing a food composition described herein as a heated pumpable liquid or semi-liquid at a temperature of from about 120° F. to about 140° F. (e.g., about 120° F. to about 130° F.), and applying the heated food composition to a surface of a solid food article, then cooling the food composition on the surface of the solid food article to a temperature at or below 100° F. to make the food product. In some embodiments, a composition can begin to solidify at a temperature at or below about 115° F., and be solid at a temperature at or below 100° F. In some embodiments, a composition can be heated to a temperature above 140° F. (e.g., about 145° F. to about 160° F.) to melt the composition before reducing the temperature to about 120° F. to about 140° F. for application to a surface of a solid food article.

In some embodiments, a food ingredient (e.g., confectionary pieces, nuts or nut pieces, seeds, or a second solid food article, or the like) can be applied to a heated food composition on the surface of a solid food article before cooling the food composition. Such a food ingredient can adhere to the food composition upon cooling. In some embodiments, a food composition suitable for use as a heated pumpable liquid or semi-liquid can include a powdered food ingredient in an amount of about 15% to about 30% by weight. A powdered food ingredient in an amount of from about 15% to about 30% by weight can contribute to a structure that is pumpable when heated to a temperature above 140° F. and/or held at a temperature of from about 120° F. to about 140° F., and is a malleable solid below 90° C. while retaining a nut butter-like texture for eating.

In some embodiments, a food composition provided herein can be extruded or injected as a first food composition with a second food composition, and formed (e.g., cut, pinched, or the like) to produce a food product in which the second food composition substantially surrounds the first composition. As used herein, a first food composition is substantially surrounded by a second food composition in a food product when the second food composition encloses the first composition such that the first composition makes up 25% or less (e.g., 10% or less, 5% or less, or 1% or less) of the visible surface area of the food product. In some embodiments, a first composition can provided as a pumpable liquid or semi-liquid at a temperature of from about 120° F. to about 140° F. (e.g., about 120° F. to about 130° F.) during extrusion or injection. In some embodiments, a first composition can be heated to a temperature above 140° F. (e.g., about 145° F. to about 160° F.) to melt the first composition before reducing the temperature to about 120° F. to about 140° F. for extrusion or injection.

In some embodiments, a second food composition can be extruded at a temperature of from about 60° F. to about 80° F. (e.g., about 60° F. to about 70° F.). In some embodiments, a second food composition can be a dough, such as a cookie dough, a pretzel dough, or a dessert bar dough.

In some embodiments, a food product that includes a first food product substantially surrounded by a second food product can be cooked (e.g., baked, par baked, fried, or the like) following coextrusion. In some embodiments, a food product that includes a first food product substantially surrounded by a second food product can include the first food product in an amount of about 20% to about 35% (e.g., about 25% to about 30%) by weight of the food product before cooking.

A food product including a food composition provided herein can be packaged using any appropriate technology. For example, a food product provided herein can be packaged as individual bars, or as multiple pieces (e.g., coated nut butter bites) in a single package. In some embodiments, a packaged food product provided herein can have a shelf life of at least 6 months (e.g., at least 8 months, at least 9 months, or at least 12 months) at ambient temperature. In some embodiments, a packaged food product, such as a par baked coextruded product, can be refrigerated or frozen.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A food composition, consisting of:
a. a nut butter in an amount of from about 50% to about 78% by weight of the food composition, the nut butter having a grind of at least 4 mils as measured using a Hegman gauge;
b. a palm oil stearin fraction in an amount of about 1.5% to about 7% of the food composition;
c. a powdered food ingredient in an amount of about 20% to about 45% of the food composition, the powdered food ingredient having a median particle size less than 100 μm; and
d. salt in an amount in an amount of about 0.5% to about 2.5% by weight of the composition.

2. The food composition of claim 1, wherein the powdered food ingredient includes a sugar or sugar alcohol in an amount of at least 15% by weight of the food composition.

3. The food composition of claim 1, wherein the palm oil stearin fraction has a melt point of at least 130° F.

4. The food composition of claim 1, wherein the powdered food ingredient comprises a starch or a flour.

5-7. (canceled)

8. The food composition of claim 1, wherein the nut butter comprises peanut butter and the palm stearin fraction is included in an amount of from about 1.5% to about 5% of the composition.

9. The food composition of claim 1, wherein the nut butter comprises almond butter and the palm stearin fraction is included in an amount of from about 2% to about 7% of the composition.

10. A method of making a food product, the method comprising:
a. combining food ingredients to make a food composition, the food composition consisting of a nut butter in an amount of from about 50% to about 78% by weight of the food composition, a palm oil stearin fraction in an amount of from about 1.5% to about 7% by weight of the food composition, the palm oil stearin fraction having a melt point of at least 130° F., a powdered food ingredient in an amount of about 20% to about 45% by weight of the food composition, the powdered food ingredient having a median particle size of less than 100 μm, and salt in an amount in an amount of about 0.5% to about 2.5% by weight of the composition;
b. extruding the food composition to make an extruded food composition; and
c. portioning the extruded food composition into pieces to make the food product.

11. The method of claim 10, wherein the powdered food ingredient comprises a sugar, a starch, or a flour.

12. The method of claim 10, further comprising a step of applying a coating to at least a portion of a surface of the pieces.

13. The method of claim 12, wherein the coating comprises chocolate or a compound coating.

14. The method of claim 12, comprising a step of applying a particulate to the coating.

15. The method of claim 10, wherein the extruded food composition is extruded at a temperature of about 60° F. to about 90° F.

16. The method of claim 10, wherein the powdered food ingredient includes a sugar or sugar alcohol in an amount of at least 15% by weight of the food, said method further comprising:
d. applying the heated food composition to a surface of a solid food article; and
e. cooling the heated food composition on the surface of the solid food article to a temperature below 90° F. to make the food product.

17. The method of claim 16, wherein the solid food article comprises a grain-based article.

18. (canceled)

19. The method of claim 16, further comprising applying a food ingredient to the food composition before cooling the food composition.

20. The method of claim 19, wherein the food ingredient comprises confectionary pieces, nuts or nut pieces, seeds, or a second solid food article.

21. A The method of making a food product, the method of clam 10, further comprising:
d. extruding a second food composition;
e. extruding or injecting the first food composition with the second food composition; and
f. forming the first food composition and second food composition such that the second food composition substantially surrounds the first food composition to make the food product.

22. The method of claim 21, wherein the second food composition is a dough.

23. The method of claim 21, further comprising a step of cooking the food product.

24. The method of claim 11, wherein the powdered food ingredient includes a sugar in an amount of at least 15% by weight of the food composition.

25. (canceled)
